(19) United States
(12) Patent Application Publication
(10) Pub. No.: US 2003/0200428 A1
(43) Pub. Date: Oct. 23, 2003

(54) Method and system for booting a client computer system over a network

(76) Inventors: Sen-Ta Chan, Taipei Hsien (TW); Chien-Shan Huang, Taipei Hsien (TW); Wen-Pin Huang, Taipei Hsien (TW); Li-We Pan, Taipei Hsien (TW); Chang Che Jung, Taipei Hsien (TW)

Correspondence Address: LADAS & PARRY, 224 SOUTH MICHIGAN AVENUE, SUITE 1200, CHICAGO, IL, 60604, US

(21) Appl. No.: 10/261,397

(22) Filed: Oct. 1, 2002

(30) Foreign Application Priority Data
Apr. 19, 2002 (TW) 091108087

(51) Int. Cl. G06F 15/177

(52) U.S. Cl. 713/1

(57) ABSTRACT

A method and system are provided herein to boot a client computer system over a network. Under the proposed method, a client computer system can commence network connection immediately upon power-on by using a pre-boot module constructed therein so as to request boot data from a server. The boot data is then transmitted to the client computer system and is executed by the client computer system for booting the latter. Furthermore, a data processing system is also provided for enabling a control computer system to boot a client computer system from a distance.

### BACKGROUND OF THE INVENTION

1. Field of the Invention

The invention relates to a method and system for booting a client computer system over a network, more particularly to a method and system for transmitting boot data from a remote server or a control computer system to a client computer system so as to facilitate boot management of each computer system or server within a network.

2. Description of the Related Art

At present, there are various methods available for remotely booting a computer system. One method is to use program codes pre-recorded in a boot memory of a network card to establish communication link between a computer system and a control computer system that provides boot data. Such a method is employed in the BootManage system developed by Bootix Technology GmbH, the managed PC boot agent (MBA) by 3COM, the Netboot technology by the Netboot Project and the Etherboot technology by the Etherboot project. The aforesaid technologies are implemented by plugging a network card with program codes recorded in the boot memory wherein the program codes will be used to boot a different computer system over the network. When the computer system is activated, the basic input/output system (BIOS) begins execution. When the BIOS detects the presence of the boot memory, the BIOS will hand over execution to the program codes in the boot memory, i.e., the program in the boot memory is executed. Thereafter, the program in the boot memory drives the network card, and a boot image file is subsequently downloaded from the network via self-execution into a random access memory (RAM) for booting the computer system using the boot image file. This method has an advantage in that different remote boot programs can be recorded on the boot memory to meet different requirements of the computer system, thereby resulting in lower costs. However, there are disadvantages in that the program codes in the boot memory have to be separately written and recorded, and that a corresponding boot image file server is required. In addition, where there are a number of client computer systems connected to one or more servers, the entire boot image file (typically 1.44 MB in size) has to be downloaded during remote booting and transmitted to each client computer system. Moreover, the boot image file cannot be generated directly and has to be revised. In view of the foregoing, the aforesaid remote booting scheme is not economical for local area networks, which have limited network bandwidths.

There is also available a technology for remote booting of a client computer system utilizing the Pre-boot Execution Environment (PXE) standard, e.g., Microsoft Remote OS Install (RIS), and BootManage available from Bootix Technology GmbH. PXE is a remote boot standard developed by Intel, and operates according to the following principle: a standard PXE program code is recorded on a network card or is resident in the BIOS of a motherboard, and the network card is plugged into a client computer system. When the client computer system is powered on, the BIOS will begin execution. When booting of the client computer system is set to be executed by the PXE, the program codes of the PXE will take over execution, i.e., the PXE program is executed. Then, the PXE drives the network card, and retrieves network communication protocol addresses of the client computer system and the Trivial File Transfer Protocol (TFTP) server from a Dynamic Host Configuration Protocol Server (DHCP Server). A boot image file is downloaded from the TFTP server into the RAM of the computer system for booting the computer system. This method has an advantage in that it is a standardized remote booting procedure which does not require writing or recording of the program in the computer system, and which is therefore less costly. However, this method is disadvantageous in that a DHCP server and a TFTP server have to be installed. Besides, as in the aforementioned method, the entire boot image file (typically 1.44 MB in size) has to be downloaded and transmitted to each client computer system. In addition, since the boot image file cannot be generated directly and needs to be revised, costs cannot be reduced.

There is available another technology which employs an independent system, such as the Compaq Remote Insight Lights-out Edition, to perform remote booting operations. The independent system is generally built into an expansion card, and has a central processing unit, memory devices, RAM, peripheral components, a display card, a network chip, etc., all of its own. Basically, the independent system is an independent computer, which is operative before the computer system is powered on, and which can detect the status of the computer system. When it is detected that the computer system is powered on, the independent system will download a boot image file from a remote end into the RAM of the independent system. The boot image file is then used to simulate a floppy disk drive of the computer system such that the computer system can boot in a conventional manner via the simulated floppy disk drive. This technology has an advantage in that it can minimize the interdependence between the computer system and the independent system and can be applied conveniently to computer systems of different specifications without the need to revise the boot image file. However, the installation of an independent system for remote booting is costly. Likewise, the entire boot image file (typically 1.44 MB in size) has to be downloaded and transmitted to each client computer system.

On the other hand, since rack mountable servers that can be mounted on a rack in large numbers are gradually gaining popularity over conventional servers, as to how the rack mountable servers can be efficiently and conveniently managed has become quite a problem. One solution is to provide a screen, a keyboard, a mouse, and a KVM switching device on the rack. The KVM switching device is used to select the server to be managed. In case of booting via a floppy disk drive, the server to be booted is located from the rack, and a floppy disk is inserted into the floppy disk drive of the selected server. However, in case there are ten or twenty or even forty odd servers, such a method of management is inconvenient. The server management problem will be aggravated when more servers, such as the Blade Servers that may not be provided with any optical disk drive or floppy disk drive, are mounted on a rack. Therefore, there is a need for a method of managing and remote booting of servers via less costly methods of transmission.

### SUMMARY OF THE INVENTION

Therefore, the main object of the present invention is to provide a method and system of booting a client computer system over a network to enable network management personnel to manage booting of computer systems or servers within the network.

According to one aspect of the invention, there is provided a method for booting a client computer system over a network. The method is performed upon power-on of the client computer system and comprises the steps of:

(a) enabling the client computer system to perform an early power-on self-test to detect a component;

(b) initializing a pre-boot module in the component so as to enable the client computer system to transmit a message over the network to a remote computer system;

(c) enabling the remote computer system to transmit boot data to the client computer system in response to the message; and

(d) enabling the client computer system to execute the boot data received from the remote computer system to complete booting process of the client computer system.

Preferably, the component subjected to the early power-on self-test in step (a) is one of a central processing unit and a memory device.

Preferably, between steps (c) and (d), there is a step of enabling the client computer system to perform a late power-on self-test upon peripheral components of the client computer system.

Preferably, step (d) includes the sub-step of executing a pre-stored executable routine to provide a selection menu for user selection.

Preferably, step (d) includes the sub-step of loading an operating system.

Preferably, step (d) includes the sub-step of executing-a pre-stored executable routine to enable the client computer system to enter a diagnostics booting path.

Preferably, after step (d), there is a step of loading a loader into the client computer system such that an operating system can be loaded for execution by the client computer system.

Preferably, after step (d), there is a step of enabling the client computer system to execute an application program.

Another object of the present invention is to provide a client computer system capable of being booted by boot data transmitted from a remote server.

According to a second aspect of the invention, a client computer system comprises:

a test module for detecting a component of the client computer system upon power-on of the client computer system;

a pre-boot module associated with the test module and initialized after the component of the client computer system has been detected, the pre-boot module being adapted to send a message over a network for reception by a remote server;

a communications module adapted to receive boot data transmitted by the remote server in stages over the network in response to the message; and

an execution module associated with the communications module for enabling the client computer system to execute the boot data, thereby booting the client computer system.

In a preferred embodiment, pre-boot module includes a pre-boot command executing mechanism for sending the message, a communications mechanism associated with the pre-boot command executing mechanism for establishing a network communications protocol such that the message can be transmitted to the remote server over the network; and a network configuration confirmation mechanism associated with the communications mechanism and adapted to confirm network configuration of the remote server, thereby ensuring that the client computer system can communicate with the remote server over the network.

Preferably, the pre-boot module further includes a selection module associated with the execution module and adapted to provide an executable selection menu, wherein an operating system is loaded into the client computer system upon selection of an item in the executable selection menu, and wherein the client computer system is directed to enter a diagnostics booting path upon selection of another item in the executable selection menu.

Preferably, the client computer system is a dynamic host configuration protocol server.

In a preferred embodiment, the pre-boot module executes a program to establish communication between the client computer system and the remote server, and the communications module is associated with the pre-boot module and is adapted to transmit the message to the remote server via a network card.

Still another object of the present invention is to provide a method for booting a remote computer system over a network using a control computer system such that data can be efficiently transmitted in environments having limited communications bandwidth.

According to a third aspect of the invention, there is provided a method for booting a remote computer system over a network using a control computer system. The method comprises the steps of:

enabling the remote computer system to detect a component upon power-on;

executing a pre-boot module in the component of the remote computer system after detection so as to transmit a message over the network for reception by the control computer system;

enabling the control computer system to transmit boot data in stages for reception by the remote computer system in response to the message; and

enabling the remote computer system to execute the boot data for activating the remote computer system upon receipt of the boot data.

Preferably, the message is transmitted over the network in encrypted form.

Yet another object of the present invention is to provide a computer system that is capable of being remotely booted over a network, thereby reducing costs of updating data in the computer system.

According to a fourth aspect of the invention, a computer system is capable of being remotely booted over a network, and utilizes BIOS that resides therein to receive boot data transmitted by a remote computer system. The computer system comprises:

a central processing unit initialized upon power-on of the computer system;

a peripheral component;

a pre-boot module associated with the central processing unit, the pre-boot module being built into the BIOS and including a set of program codes executed by the central processing unit upon initialization of the central processing unit for sending a message over the network that is to be received by the remote computer system;

a power-on self-test module for detecting the central processing unit and the peripheral component of the computer system;

a communications module adapted to receive the boot data transmitted by the remote computer system in stages over the network in response to the message via the peripheral component; and

an execution module associated with the communications module for enabling the computer system to execute the boot data, thereby booting the computer system.

A further object of the present invention is to provide a data processing system that includes a control computer system for remote booting of a client computer system over a network.

According to a fifth aspect of the invention, a data processing system comprises:

a client computer system;

a control computer system for remote management of the client computer system, the control computer system having boot data for the client computer system stored therein;

a storage medium provided in the client computer system for storing a set of program instructions;

initialization means associated with the storage medium for executing the set of program instructions so as to initialize a component of the client computer system upon power-on of the client computer system;

a pre-boot module associated with and executed by the component of the client computer system that was initialized by the initialization means for sending a message to the control computer system;

a communications module for enabling the client computer system to receive the boot data transmitted by the control computer system in stages in response to the message that was sent via the pre-boot module; and

an execution module associated with the communications module for enabling the client computer system to execute the boot data, thereby booting the client computer system.

Preferably, the component initialized by the initialization means is a central processing unit.

Still a further object of the present invention is to provide a computer program product for directing a client computer system to cooperate with a control computer system for the purpose of remote booting.

According to a sixth aspect of the invention, a computer program product comprises a computer readable storage medium that includes:

an initialization module for directing a client computer system to initialize a component upon power-on of the client computer system;

a test module for directing the client computer system to detect the component;

a pre-boot module for directing the detected and initialized component of the client computer system to send a message over a network to a control computer system;

a communications module for enabling the client computer system to receive boot data transmitted by the control computer system in stages over the network in response to the message that was received thereby; and

an execution module for directing the client computer system to execute the boot data, thereby booting the client computer system.

### BRIEF DESCRIPTION OF THE DRAWINGS

Other features and advantages of the present invention will become apparent in the following detailed description of the preferred embodiments with reference to the accompanying drawings, of which:

FIG. 1 is a flowchart illustrating a preferred embodiment of a method for booting a client computer system over a network according to the present invention;

FIG. 2 is a block diagram illustrating a preferred embodiment of a client computer system capable of being remotely booted according to the present invention;

FIG. 3 is a functional block diagram illustrating a pre-boot module of the client computer system shown in FIG. 2;

FIG. 4 is a flowchart to illustrate how a client computer system operates in another preferred embodiment of a method for booting a client computer system according to the present invention;

FIG. 5 is a flowchart to illustrate how a control computer system operates in said another preferred embodiment of a method for booting a client computer system according to the present invention

FIG. 6 is a flowchart illustrating correlated operations of a client computer system and a control computer system according to still another preferred embodiment of a method for remote booting according to the present invention; and

FIG. 7 is a functional diagram illustrating how a client computer system cooperates with a control computer system during a remote boot process' according to yet another preferred embodiment of the method of the present invention.

### DETAILED DESCRIPTION OF THE PREFERRED EMBODIMENTS

It is known that the Basic Input/Output System (BIOS) in a memory device, such as a read-only-memory (ROM) or a flash memory, of a computer system can determine the component, such as the floppy disk drive, the optical disk drive, the hard disk drive, etc., from which the computer system loads its operating system (OS). Based on this characteristic of the BIOS, the present invention utilizes a program module, which is defined herein as a “pre-boot module” and which is a set of program codes resident in the BIOS, to enable a computer system without any boot component to receive boot data from a remote server over a network for remote booting of the computer system.

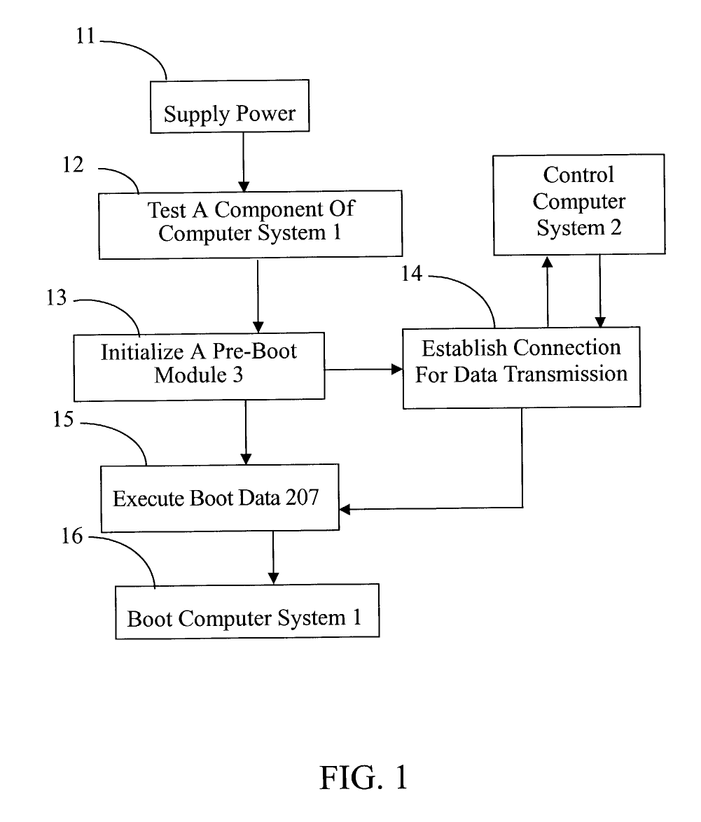

Referring to FIG. 1, in a preferred embodiment of the present invention, the method for remote booting begins with a power supplying step 11, wherein power is supplied to a computer system 1 requiring boot data so that the computer system 1 is in a power-on state, in which the computer system 1 is enabled to connect with a control computer system 2 instantly. Unlike the prior art, it is not necessary in the method according to the present invention to transmit the entire boot image file of 1.44 MB, for instance, from the control computer system 2 to the computer system 1 before the booting process can begin. In a preferred embodiment of the method according to the present invention, when the computer system 1 is in the power-on state, the computer system 1 executes a testing step 12, in which program codes resident within the BIOS of the computer system 1 are executed to detect a component of the computer system 1. Thereafter, an initialization step 13 is carried out to initialize a pre-boot module 3 resident in the BIOS and to cause the pre-boot module 3 to execute an executable program (which is a loading program required during booting by the pre-boot module 3) pre-loaded in the pre-boot module 3 so as to enable the computer system 1 to proceed with a communication linking step 14 to establish connection with the control computer system 2 for data transmission. Subsequently, an execution step 15 is performed to execute boot data 207 transmitted from the control computer system 2. Then, a booting step 16 is performed to boot the computer system 1 using the boot data 207.

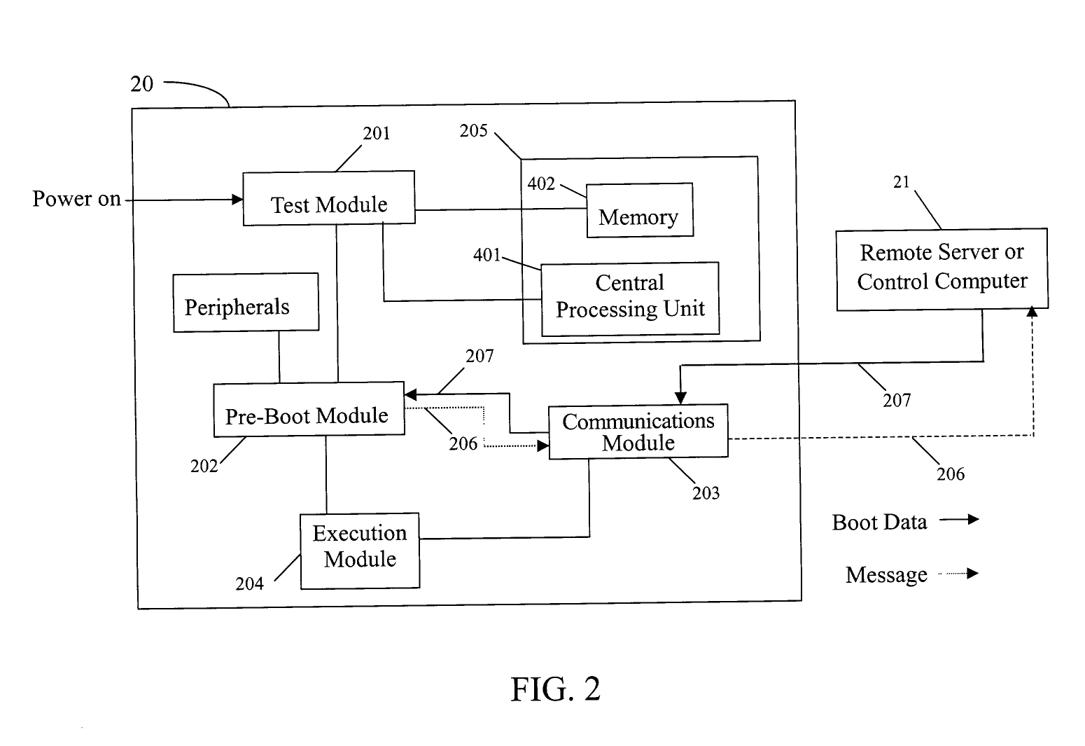

Reference is made to FIG. 2, which illustrates a preferred embodiment of a client computer system 20 that is capable of being remotely booted according to the method shown in FIG. 1.

The client computer system 20 as shown in FIG. 2 includes a test module 201 to enable the client computer system 20 to detect a component 205 of the client computer system 20 upon power-on of the client computer system 20. The detection referred to herein is a part of the power-on self-test (POST) normally performed at boot-up. More particularly, the detection referred to herein is performed at an early stage of the booting process and is therefore hereinafter referred to as an early power-on self-test, as opposed to a late power-on self-test, which is to be described in greater detail in the succeeding paragraphs.

After the test module 201 has completed the early power-on self-test, i.e., having detected the component 205, such as a central processing unit 401 or a read-only or flash memory device 402, of the client computer system 20, a pre-boot module 202 is initialized. Thereafter, the client computer system 20 can send a message 206 via a communications module 203 to a control computer system 21 or a remote server. In addition to serving as a medium for data transmission for the pre-boot module 202, the communications module 203 is also provided for receiving boot data 207 from the control computer system 21 or remote server. The boot data 207 is transmitted to the client computer system 20 based on the message 206 transmitted from the client computer system 20. When the boot data 207 is received by the client computer system 20, an execution module 204 executes the boot data 207, thereby booting the client computer system 20.

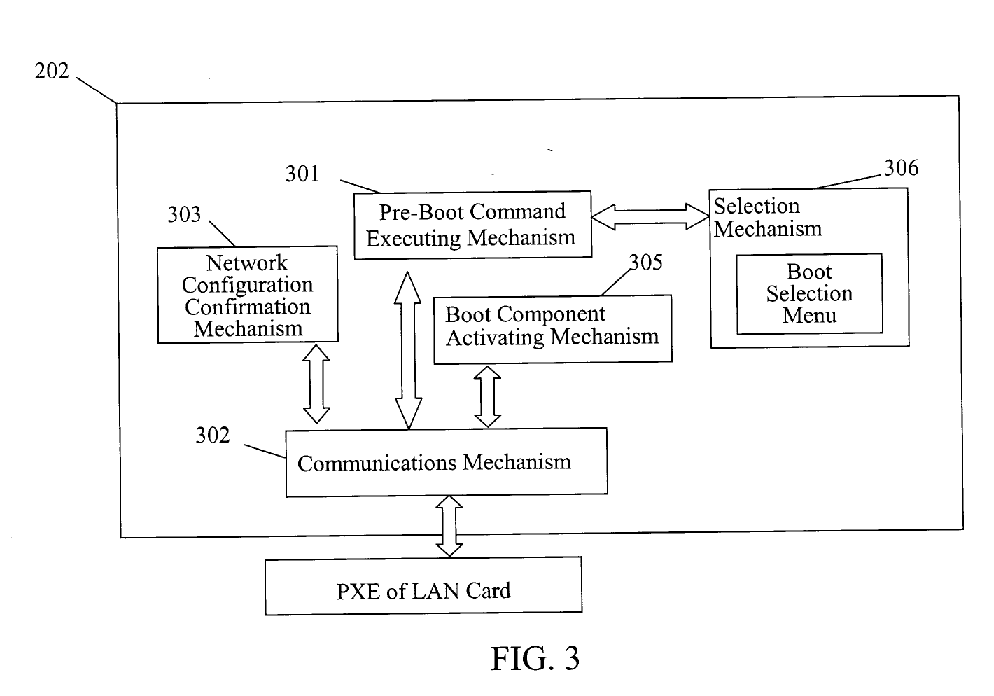

With further reference to FIG. 3, the pre-boot module 202 implemented in the BIOS of the client computer system 20 according to the method of this invention preferably includes mechanisms to enable connection of the pre-boot module 202 to the network without completing all parts of the POST required at boot-up or remote boot-up. For instance, the client computer system 20 can connect to the network to request the boot data 207 from the control computer system 21 after completion of the early power-on self-test, thereby enabling the client computer system 20 to be linked to the network immediately upon power-on.

The pre-boot module 202 resident in the BIOS of the client computer system 20 according to the method of this invention preferably includes a pre-boot command executing mechanism 301, a communications mechanism 302, a network configuration confirmation mechanism 303, and a boot component activating mechanism 305. Functions of the aforesaid mechanisms are described hereunder.

The pre-boot command executing mechanism 301 is provided to enable the client computer system 20 to send a message requesting boot data. In a preferred embodiment, the message can be Heart Beat data transmitted to the control computer system 21. Reception of the message by the control computer system 21 can further confirm whether the control computer system, 21 is present and is functioning normally.

The communications mechanism 302 enables the message to be transmitted to conform to network communications protocols. For instance, UDP/IP or TCP/IP can be adopted for communication with a remote server. It is illustrated in FIG. 3 that the communications mechanism 302 transmits the message to the client computer system 20 via a LAN card of the PXE standard installed in the client computer system 20 for further transmission of the message to the control computer system 21. In a preferred embodiment, the pre-boot module 202 can utilize the network configuration confirmation mechanism 303 disposed therein to make relevant network settings with respect to a network server of a particular configuration for network communication and data transmission with the client computer system 20. Preferably, the network configuration confirmation mechanism 303 is a DHCP network configuration confirmation mechanism corresponding to a DHCP remote server, and the client computer system 20 or the control computer system 21 can be constructed using the DHCP network configuration.

In addition, the boot component activating mechanism 305 included in the pre-boot module 202 is disposed to activate a boot component, e.g., an optical disk drive, a floppy disk drive or a hard disk drive, for retrieval and storage of boot data. In a preferred embodiment, the boot component activating mechanism 305 can read from a floppy disk drive of a remote computer system. For instance, when the floppy disk drive of the control computer system 21 is in an enabled state, the pre-boot module 202 will divert a floppy disk drive read request to the floppy disk drive of the control computer system 21. That is, the boot component activating mechanism 305 in the pre-boot module 202 is used to transmit the floppy disk drive read request to the control computer system 21 and to receive the floppy disk data from the control computer system 21.

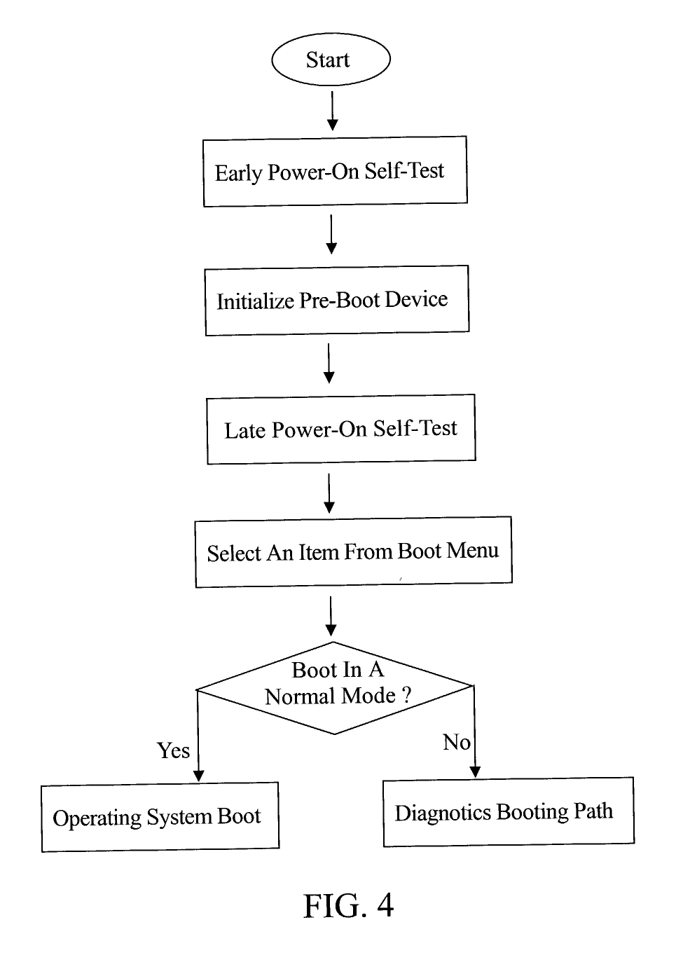

Reference is made to FIG. 4, which illustrates the boot process of a client computer system 20 according to another preferred embodiment of the method of this invention.

At the onset of the process, the client computer system 20 is powered on to perform the aforesaid early power-on self-test, including detecting the memory and bus portions of the client computer system 20, and initializing the central processing unit and other units that enable the client computer system 20 to perform its basic functions.

Subsequently, by initializing the pre-boot module 202 resident in the BIOS, the pre-boot module 202 can utilize the mechanisms illustrated in FIG. 3 to proceed with various tasks, which include: executing the network configuration confirmation mechanism 303 to define the IP address of the client computer system 20 and other network communications parameters via the DHCP protocol; initializing the communications hardware of the client computer system 20 and establishing a link with the control computer system 21; retrieval of an input code recognizable by the control computer system 21 from the control computer system 21; and managing the memory device of the client computer system 20 and loading all the program codes of the pre-boot module 202 into the memory device of the client computer system 20.

Next, the aforesaid late power-on self-test is performed. The test includes detecting peripheral components of the client computer system 20, VGA card, hard disk, etc. In the present invention, the pre-boot module 202 is employed to divide POST generally performed by the BIOS into an early power-on self-test and a late power-on self-test. In actual practice, the early and late power-on self-tests can enable the client computer system 20 to proceed with all the test tasks.

To meet the user's demand, the pre-boot module 202 further includes a selection mechanism 306 (see FIG. 3) to provide a selection menu during boot-up, thereby providing the user with a number of options. In another preferred embodiment, when the floppy disk drive of the control computer system 21 is activated, an interrupt request may be selectively sent to the control computer system 21, and the control computer system 21 responds by sending floppy disk drive data to the client computer system 20. Therefore, when the client computer system 20 enters the boot selection menu provided by the pre-boot module 202, if the user opts to continue booting, the client computer system 20 will boot in a normal mode, and the pre-boot module 202 will release the resources of the client computer system 20 to enable the client computer system 20 to enter a normal operating system, e.g., Windows, UNIX or LINUX. When the user opts to boot to a diagnostics application mode, the client computer system 20 proceeds to a diagnostics booting path where, for instance, the client computer system 20 can perform various application programs depending on the user's requirements or load a boot loader.

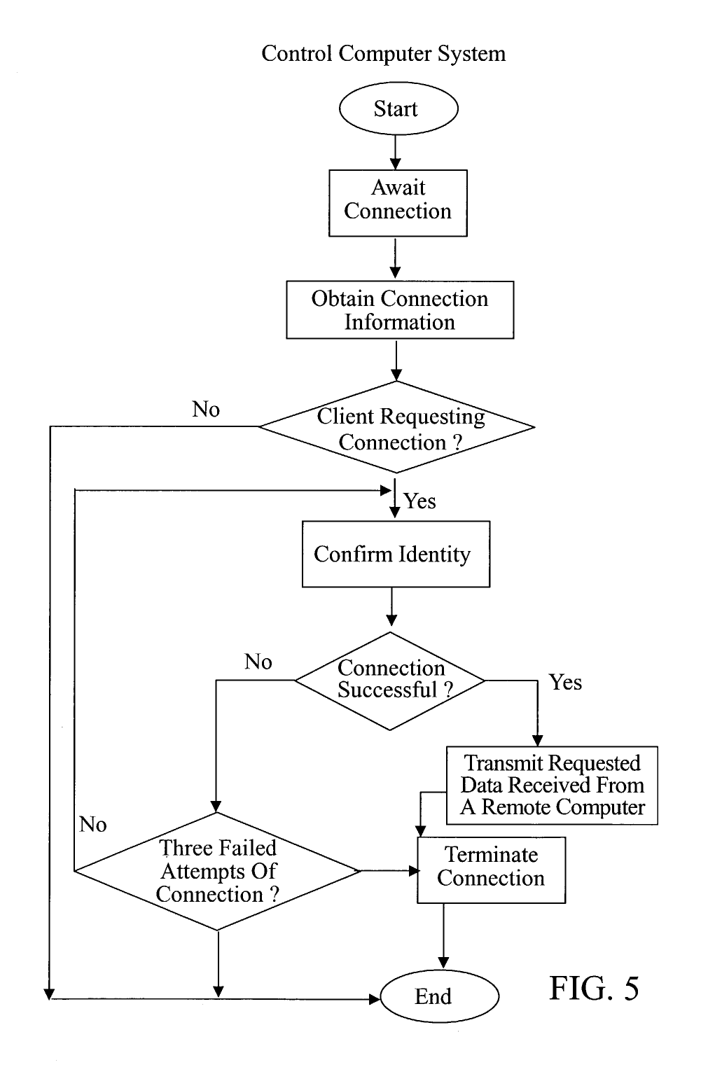

Reference is made to FIG. 5, which illustrates the operation of the control computer system 21 when executing a remote boot according to said another preferred embodiment of the method of the present invention.

At the onset, the control computer system 21 enters a connection waiting state. When the control computer system 21′ receives a message from a client end requesting communication connection therewith, the control computer system 21 will read the message to determine whether the connection request is from a client monitored thereby. After confirming the identity of the client, the control computer system 21 determines whether a successful connection has been established between the control computer system 21 and the client computer system 20. If a successful connection has been established, the data requested by the client computer system 20 will be transmitted by the control computer system 21 over the network. Otherwise, an attempt is made to establish connection with the client computer system 20. In case of three failed attempts, connection will be automatically terminated. The process illustrated in FIG. 5 will be repeated when a new message is transmitted to the control computer system 21.

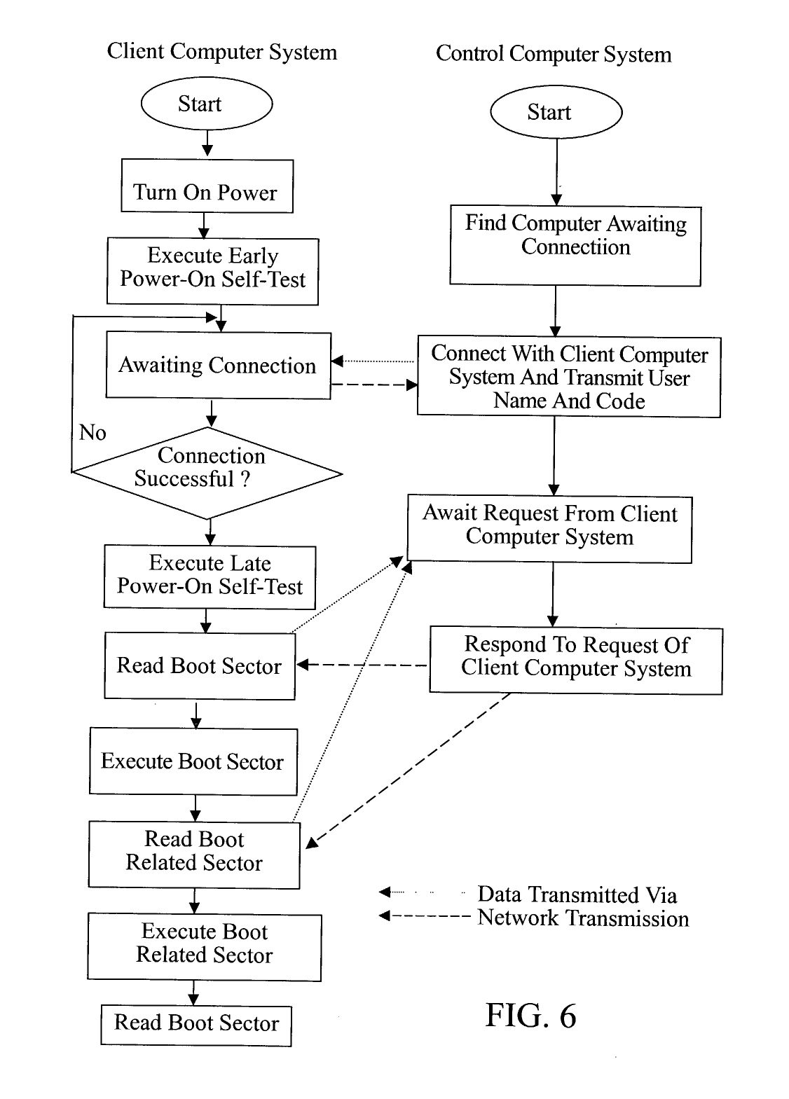

Reference is made to FIG. 6, which illustrates the correlated operations of the client computer system 20 and the control computer system 21 during remote boot according-to still another preferred embodiment of the method of the present invention. In combination with FIGS. 4 and 5, when the control computer system 21 enters a waiting state, it will locate the presence of any client computer system 20 of the user. As shown in FIG. 4, when a client computer system 20 is powered on, the client computer system 20 will immediately initiate the early power-on self-test and initialize the pre-boot module 202 so as to establish a connection with the control computer system 21 at the remote end.

When a connection is established with the control computer system 21, the control computer system 21 will transmit a set of data including user name and code to the client computer system 20 at the same time. After the connection between the client computer system 20 and the control computer system 21 has been established, the client computer system 20 will continue to maintain communication with the control computer system 21. When the client computer system 20 sends a message requesting boot data, the control computer system 21 will boot the client computer system 20 from the remote end in response to the message from the client computer system 20 and transmit the requested boot data to the client computer system 20.

After the boot data has been sent to and loaded into the client computer system 20, the latter will perform the late power-on self-test, which involves routine boot procedures, including reading and execution of relevant boot sectors, generally performed by the BIOS so as to complete the boot process. Thereafter, the client computer system 20 loads a loader, which loads an operating system for execution by the client computer system 20. At this stage, the client computer system 20 has substantially completed the boot process.

Referring once again to both FIGS. 2 and 6, the client computer system 20 according to the invention can selectively request the control computer system 21 or the remote server to transmit the boot data, which is transmitted to the client computer system 20 over the network in stages. In an environment where the network bandwidth is limited, downloading of the boot file from the control computer system 21 in stages can be achieved with greater efficiency in the present invention than in the aforesaid prior art in which a 1.44 MB boot image file has to be downloaded at one time. The invention is thus suitable for use in an environment where the communications bandwidth is relatively narrow.

It is noted that, while the present invention has been exemplified as a method for booting a client computer system over a network or booting a client computer system by transmitting boot data from a remote server, in actual practice, the client computer system, the control computer system and the modules can be integrated in a data processing system to permit communication between the control computer system and the client computer system so as to achieve remote booting. In this embodiment, the data processing system includes a control computer system that can manage a client computer system from a remote end and that can remotely boot the client computer system. The data processing system may further include a storage device (i.e., the BIOS) disposed in the client computer system for storing a set of program instructions. The program instructions reside in the BIOS to enable the client computer system to establish a communications link with the control computer system upon power-on. In addition, the data processing system employs initialization means to enable the client computer system to execute the program instructions upon power-on so as to initialize the relevant component of the client computer system.

Particularly, the aforesaid pre-boot module can enable the relevant component of the client computer system to be executable by the client computer system after initialization so that, after the pre-boot module is initialized, a message can be sent to the control computer system at the remote end. Then, the aforesaid communications module can cause the client computer system to receive the boot data which is transmitted in stages from the control computer system or a remote server based on the message. Finally, in practice, the aforesaid executing module can be used to cause the client computer system to execute the boot data for booting the client computer system. Furthermore, through the setting of a computer readable storage medium, the modules shown in FIG. 3 and the operations flow depicted in FIG. 4 can be integrated in the client computer system. In this case, as the means and modules employed are substantially the same as those described beforehand, a detailed description thereof is dispensed with herein for the sake of brevity.

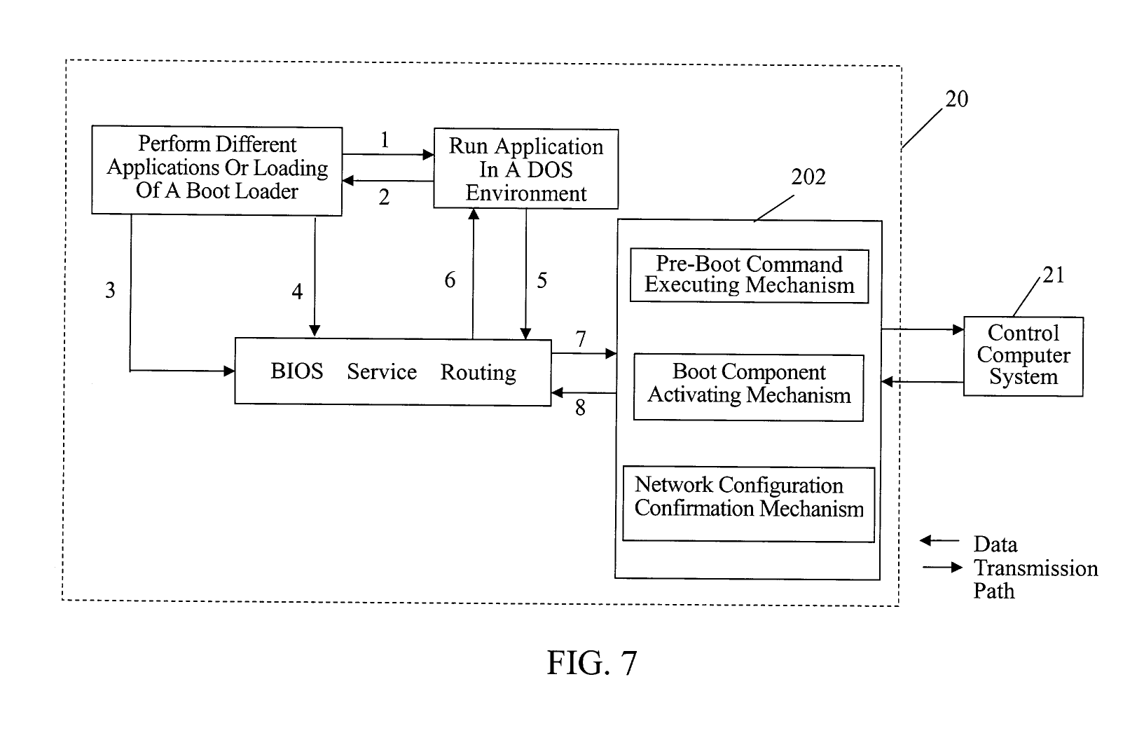

FIG. 7 illustrates how the client computer system 20 cooperates with the control computer system 21 during a remote boot process so as to perform various applications or loading of a boot loader on the client computer system 20 according to yet another preferred embodiment of the method of this invention. In the preferred embodiment, during operation, if it is desired to run read and write applications in a DOS environment, the read and write requests will be sent via the path indicated by the numerals 1, 5 and 7 to the boot component activating mechanism of the pre-boot module 202 for converting the read and write requests into a network packet that is subsequently transmitted to the control computer system 21. Thereafter, the pre-boot module 202 will retrieve the data response to the read and write requests and will feed the same back into the read and write applications following the path indicated by the numerals 8, 6 and 2. In another embodiment, during operation, if it is desired to run the read and write applications via the BIOS service routing, the read and write requests will be sent via a path indicated by the numerals 3 and 7 to the boot component activating mechanism of the pre-boot module 202 for converting the read and write requests into a network packet that is subsequently transmitted to the control computer system 21. Thereafter, the pre-boot module 202 will retrieve the data response to the read and write requests from the control computer system 21 and will feed the same back into the read and write applications following the path indicated by the numerals 8 and 4.

It should be apparent to those skilled in the art that the pre-boot module can be implemented in the BIOS or can be applied to, implemented in or loaded into any computer readable storage medium for use.

In view of the foregoing, by virtue of a pre-boot module resident in the BIOS, i.e., loading and executing a program code capable of establishing an instant connection with the remote control computer system at the POST stage, the invention provides enhanced selectivity and mobility in remote booting. Particularly, the remote booting process in the present invention can be more effectively applied to a network as compared with the prior art, and is not limited by the size of the available bandwidth.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method for booting a client computer system over a network, the method being performed upon power-on of the client computer system and comprising the steps of:
(a) enabling the client computer system to perform an early power-on self-test to detect a component;
(b) initializing a pre-boot module in the component so as to enable the client computer system to transmit a message over the network to a remote computer system;
(c) enabling the remote computer system to transmit boot data to the client computer system in response to the message; and
(d) enabling the client computer system to execute the boot data received from the remote computer system to complete booting process of the client computer system.

2. The method of claim 1, wherein the component subjected to the early power-on self-test in step (a) is one of a central processing unit and a memory device.

3. The method of claim 1, further comprising, between steps (c) and (d), the step of enabling the client computer system to perform a late power-on self-test upon peripheral components of the client computer system.

4. The method of claim 1, wherein step (d) includes the sub-step of executing a pre-stored executable routine to provide a selection menu for user selection.

5. The method of claim 1, wherein step (d) includes the sub-step of loading an operating system.

6. The method of claim 1, wherein step (d) includes the sub-step of executing a pre-stored executable routine to enable the client computer system to enter a diagnostics booting path.

7. The method of claim 1, further comprising, after step (d), the step of loading a loader into the client computer system such that an operating system can be loaded for execution by the client computer system.

8. The method of claim 1, further comprising, after step (d), the step of enabling the client computer system to execute an application program.

9. The method of claim 1, wherein, in step (c), the remote computer system is enabled to transmit the boot data in stages to the client computer system.

10. A client computer system capable of being booted by boot data transmitted from a remote server, said client computer system comprising:
a test module for detecting a component of the client computer system upon power-on of the client computer system;
a pre-boot module associated with the test module and initialized after the component of the client computer system has been detected, the pre-boot module being adapted to send a message over a network for reception by the remote server;
a communications module adapted to receive the boot data transmitted by the remote server in stages over the network in response to the message; and
an execution module associated with the communications module for enabling the client computer system to execute the boot data, thereby booting the client computer system.

11. The client computer system of claim 10, wherein the pre-boot module includes:
a pre-boot command executing mechanism for sending the message;
a communications mechanism associated with the pre-boot command executing mechanism for establishing a network communications protocol such that the message can be transmitted to the remote server over the network; and
a network configuration confirmation mechanism associated with the communications mechanism and adapted to confirm network configuration of the remote server, thereby ensuring that the client computer system can communicate with the remote server over the network.

12. The client computer system of claim 11, wherein the pre-boot module further includes a boot component activating mechanism adapted to activate a boot component that stores the boot data.

13. The client computer system of claim 12, wherein the boot component is one of an optical disk drive, a floppy disk drive and a hard disk drive.

14. The client computer system of claim 11, wherein the pre-boot module further includes a selection module associated with the execution module and adapted to provide an executable selection menu.

15. The client computer system of claim 14, wherein an operating system is loaded into the client computer system upon selection of an item in the executable selection menu.

16. The client computer system of claim 15, wherein the client computer system is directed to enter a diagnostics booting path upon selection of another item in the executable selection menu.

17. The client computer system of claim 10, wherein the client computer system is a dynamic host configuration protocol server.

18. The client computer system of claim 10, wherein the pre-boot module executes a program to establish communication between the client computer system and the remote server.

19. The client computer system of claim 10, wherein the communications module is associated with the pre-boot module and is adapted to transmit the message to the remote server via a network card.

20. The client computer system of claim 10, wherein the test module performs an early power-on self-test upon a central processing unit of the client computer system prior to initialization of the pre-boot module.

21. The client computer system of claim 20, wherein the test module further detects a peripheral component of the client computer system after the pre-boot module has been initialized.

22. A method for booting a remote computer system over a network using a control computer system, the method comprising the steps of:
enabling the remote computer system to detect a component upon power-on;
executing a pre-boot module in the component of the remote computer system after detection so as to transmit a message over the network for reception by the control computer system;
enabling the control computer system to transmit boot data in stages for reception by the remote computer system in response to the message; and
enabling the remote computer system to execute the boot data for activating the remote computer system upon receipt of the boot data.

23. The method of claim 22, wherein the message is transmitted over the network in encrypted form.

24. The method of claim 22, wherein the network is one of a local area network and a wide area network.

25. The method of claim 22, wherein the boot data is selectively transmitted to the remote computer system.

26. A computer system capable of being remotely booted over a network, the computer system utilizing BIOS that resides therein to receive boot data transmitted by a remote computer system, the computer system comprising:
a central processing unit initialized upon power-on of the computer system;
a peripheral component;
a pre-boot module associated with the central processing unit, the pre-boot module being built into the BIOS and including a set of program codes executed by the central processing unit upon initialization of the central processing unit for sending a message over the network that is to be received by the remote computer system;
a power-on self-test module for detecting the central processing unit and the peripheral component of the computer system;
a communications module adapted to receive the boot data transmitted by the remote computer system in stages over the network in response to the message via the peripheral component; and
an execution module associated with the communications module for enabling the computer system to execute the boot data, thereby booting the computer system.

27. The computer system of claim 26, wherein the power-on self-test module includes an early power-on self-test for detecting the central processing unit, and a late power-on self-test for detecting the peripheral component.

28. The computer system of claim 26, wherein the pre-boot module includes:
a pre-boot command executing mechanism for sending the message;
a communications mechanism associated with the pre-boot command executing mechanism for establishing a network communications protocol such that the message can be transmitted to the remote computer system over the network; and
a network configuration confirmation mechanism associated with the communications mechanism and adapted to confirm network configuration of the remote computer system, thereby ensuring that the computer system can communicate with the remote computer system over the network.

29. A data processing system comprising:
a client computer system;
a control computer system for remote management of the client computer system, the control computer system having boot data for the client computer system stored therein;
a storage medium provided in the client computer system for storing a set of program instructions;
initialization means associated with the storage medium for executing the set of program instructions so as to initialize a component of the client computer system upon power-on of the client computer system;
a pre-boot module associated with and executed by the component of the client computer system that was initialized by the initialization means for sending a message to the control computer system;
a communications module for enabling the client computer system to receive the boot data transmitted by the control computer system in stages in response to the message that was sent via the pre-boot module; and
an execution module associated with the communications module for enabling the client computer system to execute the boot data, thereby booting the client computer system.

30. The data processing system of claim 29, further comprising a test module for detecting a memory device of the client computer system prior to initialization by the initialization means.

31. The data processing system of claim 29, further comprising a test module for detecting a peripheral component of the client computer system after initialization by the initialization means.

32. The data processing system of claim 29, wherein the component initialized by the initialization means is a central processing unit.

33. The data processing system of claim 29, wherein the pre-boot module includes:
a pre-boot command executing mechanism for sending the message;
a communications mechanism associated with the pre-boot command executing mechanism for establishing a network communications protocol such that the message can be transmitted to the control computer system over a network; and
a network configuration confirmation mechanism associated with the communications mechanism and adapted to confirm network configuration of the control computer system, thereby ensuring that the client computer system can communicate with the control computer system over the network.

34. A computer program product comprising a computer readable storage medium that includes:
an initialization module for directing a client computer system to initialize a component upon power-on of the client computer system;
a test module for directing the client computer system to detect the component;
a pre-boot module for directing the detected and initialized component of the client computer system to send a message over a network to a control computer system;
a communications module for enabling the client computer system to receive boot data transmitted by the control computer system in stages over the network in response to the message that was received thereby; and
an execution module for directing the client computer system to execute the boot data, thereby booting the client computer system.

35. The computer program product of claim 34, wherein the test module directs the client computer system to detect a memory device of the client computer system prior to initialization via the initialization module.

36. The computer program product of claim 34, wherein the test module directs the client computer system to detect a peripheral component of the client computer system after initialization via the initialization module.
